(19) United States
(12) Patent Application Publication
(10) Pub. No.: US 2023/0360816 A1
(43) Pub. Date: Nov. 9, 2023

(54) TRITIUM THERMOELECTRIC GENERATOR

(71) Applicant: City Labs, Inc., Miami, FL (US)

(72) Inventors: Peter Cabauy, Miami, FL (US); Larry C. OLSEN, Kennewick, WA (US); Jesse P. Grant, Homestead, FL (US); Johann Hernandez, Weston, FL (US); Rachel Cabauy, Miami, FL (US)

(21) Appl. No.: 18/144,194

(22) Filed: May 6, 2023

Related U.S. Application Data
(63) Continuation-in-part of application No. 16/935,120, filed on Jul. 21, 2020, now abandoned.
(60) Provisional application No. 63/044,071, filed on Jun. 25, 2020.
(60) Provisional application No. 62/876,748, filed on Jul. 21, 2019.

(51) Int. Cl. G21H 1/06; G21H 1/10; G21H 1/02

(52) U.S. Cl. CPC G21H 1/103; G21H 1/02; G21H 1/06

(57) ABSTRACT

A device for producing electricity. The device comprises a source of tritium radioisotopes, an element Th maintained at a temperature Th, and an element Tc maintained at a temperature Tc; Tc lower than Th. The source generates heat and is disposed in thermal communication with the element Th to maintain the temperature Th. First and second doped elements, each doped with a different dopant type, are oriented in parallel relative to the heat flow path between the element Th and the element Tc and electrically connected in series According to the Seebeck effect, a voltage is generated between the first and second doped elements due to a temperature differential between the Tc and Th, causing current to flow through the serially-connected doped elements. Helium generated during generation of the radioisotopes is vented from the device.

### CROSS REFERENCE TO RELATED APPLICATION

The present application is a continuation-in-part application of and thereby claims priority to the non-provisional application assigned number 16/935,120 and filed on Jul. 21, 2020 (Attorney Docket Number 11432-009), which claims priority to the provisional patent application assigned number 63/044071 filed on Jun. 25, 2020 and the provisional application assigned number 62/876,748 filed on Jul. 21, 2019 (both Attorney Docket Number 11432-009), which are incorporated herein in their entirety.

### BACKGROUND OF THE INVENTION

Thermoelectric power sources have been developed using many different heat sources, including radioisotope decay, nuclear fission processes, chemical reaction-based, and combustion-based heat sources.

The radioisotope Pu-238 decays by alpha particle emission with a half-life of 87.7 years. Many thermoelectric systems have utilized PuO₂ as the heat source. The energy in the alpha particle emissions is converted to heat at a rate of 560 W/kg. Alpha particles emitted during radioactive decay collide with neighboring atoms inducing phonons in the surrounding atomic structure thereby creating an increased temperature. This increased temperature results in a heat flux when a nearby material is at a different (lower) temperature.

Although the long half-life and high rate of conversion to heat are very desirable for a radioisotope used as a heat source in a long-life thermoelectric device, there are increasing difficulties in producing and using plutonium stemming from regulatory, safety, and political concerns, as well as the high-cost remediation of byproduct radioisotopes created in the plutonium production process.

Recently, the use of tritium for betavoltaic power sources has emerged as a safe and regulatorily-acceptable form of nuclear micropower generation, i.e., in a thermoelectric generator. Tritium, a radioisotope of hydrogen with a half-life of 12.3 years, emits power through beta particle decay at a rate of 340 Watts/kg. However, the electrical power output associated with tritium betavoltaics trends towards the nanowatt to microwatt power regime due to the high cost of a system that could generate milliwatt-to-watt power levels. The increased cost to achieve a higher power level is directly proportional to the amount of semiconductor material utilized in betavoltaic power sources.

Significant efforts have been expended to circumvent the high-cost associated with these desired higher power levels by increasing the surface area of the betavoltaic semiconductor that is exposed to the tritium beta decay.

The following published patent applications and patents each propose a three-dimensional method of increasing the surface area of the betavoltaic semiconductor in an effort to more efficiently extract the energy from isotope decay:
US Pat. Application Publication 2004/0154656
US Pat. 7,663,288
US Pat. 7,250,323
US Pat. 6,949,865

Central to these various approaches is the hope that an increase in surface area exposed to tritium beta emissions will increase the power per unit volume of the betavoltaic semiconductor device and thus the output power density. The overall goal of this approach is to increase the power density of the tritium betavoltaic while reducing the cost.

One disadvantage with these approaches arises when a relatively low power radioisotope such as tritium is used. In this case, the incident power is quite small per unit area exposed and the dark current of the semiconductor device is a very significant factor in the overall efficiency of the device, making it difficult to fabricate a practical device.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates a pictorial diagram of a thermoelectric generator.

FIGS. 2 and 3 each illustrate an n-p thermocouple.

FIG. 4 illustrates an array of n and p thermoelements forming a thermoelectric module.

FIGS. 5 - 8 are graphs depicting electrical energy output as a function of thermal energy input.

FIG. 9 illustrates one embodiment of a tritium heat source according to the teachings of the invention.

FIG. 10 illustrates a polyimide material for use as a vent to release helium that accumulates within a betavoltaic power source.

FIG. 11 illustrates a surface of nanometer openings for use as a vent to release helium that accumulates within a betavoltaic power source.

FIG. 12 illustrates a tritium-based power source according to another embodiment of the invention.

### DETAILED DESCRIPTION OF THE INVENTION

The present invention may be understood more readily by reference to the following detailed description taken in connection with the accompanying figures and examples, which form a part of this disclosure. It is to be understood that this invention is not limited to the specific devices, methods, applications, conditions, or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, references to values within a stated range include each and every value within that range. Additionally, the disclosures of each patent, patent application, and publication cited or described in this document is incorporated herein by reference in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the spirit and scope of the invention.

For the benefit of clarity, this detailed description presents examples of how the invention could be implemented and is not to be taken or considered in a limiting sense. The appended claims, as well as the full range of equivalent embodiments to which such claims are entitled, define the scope of various embodiments of the subject invention for different types of businesses. This disclosure is intended to cover any and all adaptations, variations, or various embodiments.

Combinations of presented embodiments, and other embodiments not specifically described herein by the descriptions, examples, or appended claims, may be apparent to those of skill in the art upon reviewing the above description and are considered part of the current invention.

The low performance and high cost characteristics of tritium betavoltaic direct conversion power sources (especially at electrical power output levels in the milliwatt and higher range) suggests that improvements can be made to more effectively utilize tritium as a heat source in a thermoelectric generator (TEG). However, there are certain disadvantages that must be overcome, such as the large volume of tritium necessary to obtain sufficient heat energy from a gaseous heat source so that the thermal energy can be efficiently converted to electrical energy.

The invention described herein is a novel and non-obvious tritium-based thermoelectric generator. The TEG can efficiently convert heat energy at levels less than one watt, but finds application at higher heat levels and concomitant power levels, e.g., 1-20 watts, when the tritium is incorporated into a metal hydride matrix, thereby increasing the output power density to levels on the order of milliwatts per cubic centimeter.

Tritium in its native state is a gas but according to the teachings of this invention, tritium is incorporated into a solid metal tritium hydride (referred to generally as a tritide or a metal hydride) for forming titanium tritide, scandium tritide, magnesium tritide, palladium tritide, lithium tritide, or uranium tritide, etc. The tritium is stored interstitially in the metal matrix. Tritium in a hydride form can be hundreds to thousands of times denser than in its gaseous form, thereby increasing the generated heat per tritium volume or area.

Use of the tritide metal matrix form of tritium serves two purposes: primarily as a binder to hold the tritium in a dense solid-state configuration and secondarily as a vehicle for transforming the kinetic energy of the tritium decay process into heat, e.g., decays by beta emission with a maximum energy of 18.6 keV and a half-life of 12.3 years. The beta particle (electron) emission from its parent tritium atom transfers the electron’s kinetic energy into the metal matrix, causing the metal lattice elements to vibrate and generate heat (phonons). The electron’s penetration depth in a metal is on the order of a micron or less and is dependent on the energy of the electron and the density of the metal tritide.

The electron also loses some of its energy due to x-ray bremsstrahlung radiation (braking radiation) arising from collisions with metal matrix particles. The x-rays are also absorbed within the metal hydride matrix causing the lattice elements to vibrate and generate heat. The x-rays travel within the metal approximately 100 microns or less depending on the density of the metal and the energy of the x-ray. The energy generated by both the electrons and the x-rays is efficiently converted to heat to serve as the high-temperature thermal component of the thermoelectric generator.

Although typical metal hydride matrix materials are designed to uptake a large amount of hydrogen and release it on demand, such as for use in combustion process or in a fuel cell, this invention is focused on maximum uptake of hydrogen (tritium) without consideration necessarily for the ability of the material to release the hydrogen.

Instead, ideal storage materials for this invention hold the tritium until it eventually radioactively decays, absorb the electrons within the material, efficiently convert the electron energy to heat energy, and transfer, with low losses, that heat energy to a desired surface or material. Also, it is important that the tritium is stored in a dense interstitial configuration. Additionally, the heat source should be designed to withstand high temperatures that might be generated by numerous radioactive decay events - as such events would typically drive tritium out of its storage matrix. Clearly, there is no ideal material or alloy and trade-offs must be made in material selection.

The transfer of heat from the tritide matrix to the encapsulating materials and ultimately to the thermoelectric generator (specifically to a hot surface or hot element Th of the thermoelectric generator) is another unique aspect of this invention; the storage materials are carefully selected to balance all of these non-obvious features to result in a storage matrix that has high tritium loading ratios, low absorption of the tritium at a working temperature and pressure, high desorption even at high temperatures and vacuum pressure, good thermal conductivity (i.e., greater than 1 W/m-K) and good thermal stability.

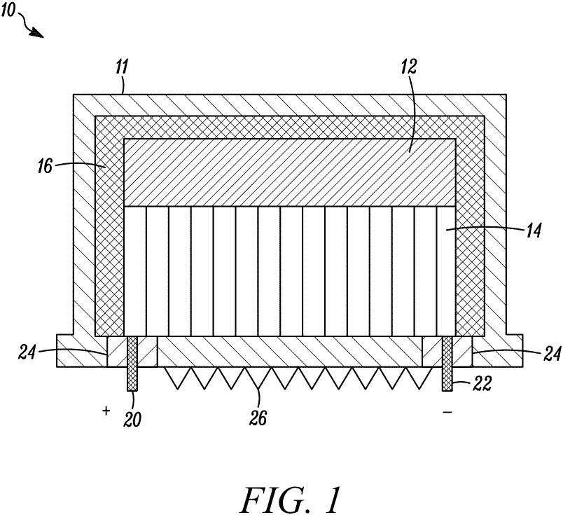

FIG. 1 illustrates a thermoelectric generator 10 comprising an enclosure 11 surrounding a tritium metal tritide heat source 12 and a thermopile 14. An insulating material 16, disposed between the enclosure 11 and the heat source 12 (the tritide matrix) and the thermopile 14 (specifically, a hot element or surface Th of the thermopile), insulates the thermopile and its heat source, and may comprise a high vacuum region and/or a non-thermal conducting material, aerogel, or other insulating materials as known to those skilled in the art.

The enclosure 11, preferably having a black-colored surface, functionally cooperates with the insulating material 16 to limit heat flow outwardly from the tritium metal tritide heat source 12, thereby directing the heat to the thermopile 14 and increasing the efficiency of the thermopile 14.

The thermoelectric generator operates according to the principles of the Seebeck effect, converting heat energy (Q) into electrical energy (W) within the thermopile 14 through a thermal temperature gradient between corresponding hot and cold elements of the thermopile.

A voltage is generated, according to the Seebeck effect, as a function of a temperature differential between the hot and cold elements of the thermopile 14. In FIG. 1, the voltage is generated between terminals 20 and 22. Feed-through components 24 insulate the terminals 20 and 22 from the enclosure 11.

Maintaining the cold element or surface (Tc) at the lowest practical temperature (as determined by the application and use environment) is critical to maximize the temperature differential relative to the hot element or surface Th and thereby maximize the generated energy. In one embodiment for use in a suitable application, placement of a radiator 26 at a base of the thermoelectric generator 10 removes heat from the thermopile 14. The radiator is proximate a cold side of the thermoelectric generator (TEG). Thus, to lower the temperature of the cold side, heat is passively transferred from the cold side to another component at a lower temperature. For example, in a space application the cold side is connected (in thermal conduction or passively through a radiator by convection or radiation) to a satellite chassis, which can absorb significant heat through conduction and distribute it over the chassis, eventually radiating the heat into cold space. In another application, phase change material can be used to maximize the temperature differential.

In the following embodiments, approaches are considered that are particularly appropriate for producing a few milliwatts to hundreds of milliwatts of electric power or greater using a thermoelectric generator (i.e., thermopile) coupled to a tritium tritide source. It is assumed the heat source of the thermopile will provide thermal power of a few tenths of a watt to a few watts or more of thermal energy.

One system embodiment operates with a cold surface temperature of about 300° K, for example, and a hot surface temperature in the range of approximately 300° K to 450° K. As known by those skilled in the art, a temperature differential of only a few degrees can generate some power. Ideally, a greater temperature delta generates more power and thus the design and operation of the TEG attempts to achieve a maximum temperature difference between the hot side or surface and the cold side or surface.

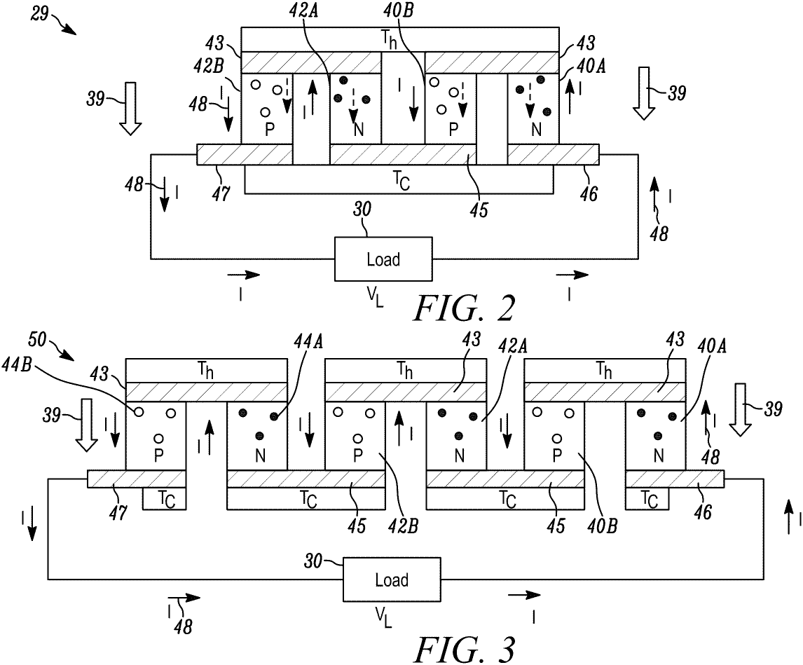

Semiconductor-based materials are a particularly good fit for use in the thermopile when low-temperature tritium hydrides generate the heat for the hot side. In one embodiment the thermopile 14 of FIG. 1 comprises an n-type and a p-type semiconductor. These doped materials have different Seebeck coefficients and when configured in the thermopile, motion of the holes and electrons in the doped regions, due to the temperature differential, creates a voltage differential (and thus a current in a circuit with a load). See FIGS. 2 and 3.

Among the most efficient semiconductor thermoelectric materials for use in the temperature range produced by betavoltaic decay are alloys of SbₓTeₓ, BiₓTeₓ, BiₓSeₓ, or other suitable semiconductor types; however this invention need not be limited to these specific materials or temperature ranges set forth immediately above. These materials are narrow bandgap semiconductors. It is well established, for each the materials referred to above, the preferred doping elements for producing the n and p materials.

Most thermoelectric modules based on these materials utilize polycrystalline n-doped and p-doped elements. However, single crystalline materials (e.g., nanowires) can also be used.

Polycrystalline materials generally have a distribution with “strongest directions,” which usually means that in a general sense they are stronger than single crystals. But if a preferred orientation can be identified, a single crystalline material of the same composition will be stronger in that certain orientation for a given dopant loading. Also, polycrystalline materials frequently have a “texture,” which is a preferred growth orientation that results in somewhat reduced mechanical properties in certain directions. Amorphous materials (which are a contrast to crystalline materials in this context) do not suffer from such a preferred orientation, but since their crystallographic orientation is random there is no distinctly stronger (or weaker) direction.

Thus, single crystal materials offer a purer (fewer grain boundaries that can serve as recombination centers) substrate to which dopants can be added and have lower dark current. Polycrystalline materials are typically stronger.

FIG. 2 illustrates a dual n-p thermocouple 29 comprising n-doped elements 40A and 42A and p-doped elements 40B and 42B. Electrons are indicated in FIG. 2 by closed circles and holes by open circles. Broken arrowheads within the elements indicate the direction of carrier motion (electrons and holes) within that element.

Conventional current flow through the thermocouple 29 is indicated by arrowheads 48, which, as known by those skilled in the art, is in the same direction as hole flow through the p-doped elements 40B and 42B and in the opposite direction as electron flow through the n-doped elements 40A and 42A. The conventional current in a load 30 generates a voltage V_{L}.

A top surface of n-doped and p-doped elements 40A and 40B are connected by a conductive element 43. Similarly, top surfaces of the n-doped and p-doped elements 42A and 42B are connected by a conductive element 43. Finally, bottom surfaces of the elements 40B and 42A are connected by a conductive element 45.

A conductive element 46 in contact with a bottom surface of the n-doped element 40A serves as a first terminal for connection to the load 30, and a conductive element 47 in contact with a bottom surface of the n-doped element 42B serves as a second terminal for connection to the load 30.

A symbol Th represents a hot surface in contact with an upper surface of the doped elements and a symbol Tc represents a cold surface in contact with a lower surface of the doped elements. As shown in FIG. 2, the hot and cold surfaces Th and Tc extend over and in contact with each of the doped elements 40A, 40B, 42A, and 42B.

Thus heat flow paths 39 are from the surface Th to the surface Tc. The n-doped and p-doped elements 40A and 40B, respectively, are oriented in parallel relative to n-doped and p-doped elements 42A and 42B, i.e., elements 40A, 40B, 42A, and 42B are configured in parallel heat flow paths between the hot surface Th and the cold surface Tc.

But electrically the elements 40A, 40B, 42A, and 42B are connected in series such that current, as indicated by arrowheads 48, flows serially through each of the elements 40A, 40B, 42A, and 42B.

Both the hot surface Th and the cold surface Tc are depicted as extending over a respective first end or surface (the upper end o surface in FIG. 2) and second end or surface (the lower end or surface in FIG. 2) of the n-doped and p-doped elements. However, this is not necessarily required as in another embodiment (see FIG. 3) three hot surfaces Th are employed, with each one proximate and extending over a first end of a pair of n-doped and p-doped elements. Thus, three hot surfaces Th are shown in FIG. 3. Similarly, four cold surfaces Tc are employed, with each one proximate and extending over the second end of each of the n-doped and p-doped elements.

Thermoelectric generator 50 of FIG. 3 comprises three pairs of n-doped and p-doped elements, 40A/40B, 42A/42B, and 44A/44B. Aside from the use of sectional hot Th and cold Tc surfaces, the TEG 50 functions identically to the TEG 29 of FIG. 2.

FIGS. 2 and 3 illustrate an embodiment in which the doped elements are electrically connected with conductive elements at both top and bottom surfaces of the doped elements. The thermal elements Th and Tc provide the temperature gradient for the thermo electric generator. In another embodiment (not illustrated) the hot and cold surfaces (Th and Tc respectively) serve as both a hot or cold surface and as an electrical conductor connecting the n-dope and p-doped regions. A conductive epoxy is one material that may be considered, albeit the thermal properties of such a material may degrade operation of the thermal electrical generator due to its poor thermal conductivity properties.

In an embodiment comprising a plurality of n-doped and p-doped elements arranged in a high-density, closely-spaced matrix configuration, an electrical insulating material (not shown) may be present between the hot and cold surfaces and the n-doped and p-doped elements. This material prevents the doped elements from shorting each other. Certain materials, known to those skilled in the art, can provide electrical insulation, but only minimal thermal insulation and therefore allow good heat transfer.

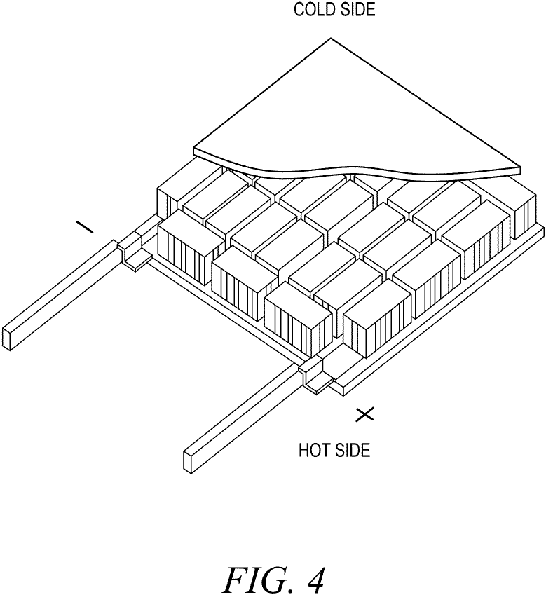

A plurality of the thermoelectric modules of FIGS. 2 and 3 can be arranged as an array of n- and p-elements as shown in FIG. 4. In each module the n- and p-elements are arranged in parallel relative to heat flow (the p- and n-elements are configured for parallel heat flow through all elements), but in series electrically to increase the current and thus the voltage delivered to the load.

The temperature gradient causes electrons in the n-doped element and holes in the p-doped element to flow from the hot side to the cold side. The n-doped and p-doped elements are arranged so that the current is in the direction of holes flowing from the hot side to the cold side, and voltages in a series configuration of such modules are additive, i.e., a serial electrical configuration, as shown in FIGS. 2 and 3.

It is desirable that system elements proximate or in contact with the hot and cold surfaces exhibit a low thermal conductance, so that for a given amount of heat flow, the temperature difference between the hot and cold sides is as large as possible and a substantial portion of the heat flow is directed to the n-doped and p-doped elements. To achieve this, the thermal conductance of these system elements must be as low as possible.

The thermal conductance is given by

$$\text{K} = {\left[\text{Nk} \left(\text{A} / \text{L}\right)\right]}_{\text{n}} + {\left[\text{Nk} \left(\text{A} / \text{L}\right)\right]}_{\text{p}} + {\text{K}}_{\text{loss}}$$

where N refers to the number of n (or p) elements, k is the thermal conductivity of the individual elements, L is the length of the n- and p-elements, A is the cross-sectional area of the n- and p-elements, and Kₗₒₛₛ is a parasitic heat loss through a material that supports the various system elements and any other heat loss pathways within the system. The parameters “k” and Kₗₒₛₛ can be lowered to some extent. But for a given desired voltage/current output a certain number of n-and p- elements is required.

If it is assumed that the n- and p- elements have similar thermal properties and dimensions, then the above equation can be simplified to:

$$\text{K} = 2 \text{Nk} \left(\text{A} / \text{L}\right) + {\text{K}}_{\text{loss}}$$

The thermal energy Q flowing through the module is given by:

$$\text{Q} = \text{K} \left[\left(\text{Th} - \text{Tc}\right)\right]$$

where Th is the hot side temperature, Tc is the cold side temperature, and K is the thermal conductance.

To efficiently produce power, it is desirable for the thermoelectric system to have a low thermal conductance to achieve a large temperature difference between Th and Tc, but have a large N value in order for the system to generate an adequate voltage.

Thus, some key parameters as related to system performance are:
L/A, ratio of length to cross sectional area for a single n or p element
N, the total number of n and p elements
Total area of all n and p elements
Properties of insulating material between elements, i.e., a low thermal conductivity value K.

The element area is related to the overall device size and is a function of N (the number of p and n elements) and A (the area of each element).

It is desirable for the quantity A/L to be small, to drive the system thermal conductance, K, down. However, the value of the reciprocal, L/A, is typically referred to when discussing properties of thermoelectric systems (also referred to as thermoelectric modules). For a small A/L value, therefore, it is desirable to seek a large L/A.

This L/A parameter is a limiting factor for modules based on crystalline materials. Efforts to achieve large L/A values with crystalline materials are usually limited by breakage caused by cleavage along crystalline planes.

The value of L/A for modules with polycrystalline thermoelectric elements is typically in the range of 10 cm⁻¹ to 20 cm⁻¹. Advanced fabrication techniques are capable of achieving L/A values greater than 1000 cm⁻¹. To achieve these values, efforts have been devoted to the use of sputtered thin films on insulating substrates or to providing support for elements with small cross-sectional areas ‘A’ to achieve large values of L/A.

It should be noted that commercial-off-the-shelf thermoelectric modules may be coupled to a tritium metal tritide heat source of the present invention. However, the expected efficiencies will generally be lower than when coupled to a module with a relatively high L/A value; that is, one that has been specifically designed to operate with the quantity of heat generated by tritium metal tritide sources, which can provide heat in the range a few watts or less up to the range of about tens of watts., and in some embodiments as high as hundreds of watts.

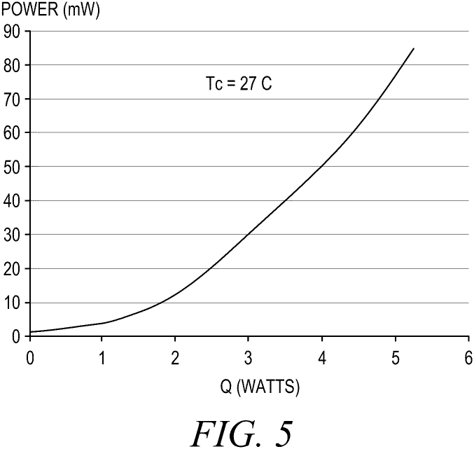

For example, representative or generic thermoelectric modules are known in the industry such as, model TXL-127-02K from the TXL Group in El Paso, Texas, and model HZ-2 from Hi-Z Technology, Inc. in San Diego, California. Estimates of power produced by these modules are given in FIGS. 4 and 5. In both cases, a heat source generating several watts or more is required to produce 1 to 50 milliwatts of electrical power.

The basic thermoelectric material properties for these two modules include: the Seebeck coefficient (alpha), thermal conductivity (K), and electrical resistivity (rho). Typical values as set forth below were assumed for both modules.
alpha = 210 uV/C
K = 0.013 W/cm/C
rho = 0.0015 ohm-cm

Other characteristics for each module are given below.

TXL-127-02K Module
Number of n-p couples = N = 127
Module Area = 6.25 cm²
L/A = 18.3 cm⁻¹
Module Height = 0.47 cm

FIG. 5 gives the calculated electric power E produced versus the input thermal power Q for the TXL-127-02K Module. Possible parasitic losses have not been included in the calculations that generated FIG. 5.

HZ-2 Thermoelectric Module
Number of n-p couples = N = 97
Module Area = 7.73 cm²
L/A = 17.3 cm⁻¹
Module Height = 0.69 cm

FIG. 6 gives a plot of estimated power produced for given input of thermal power Q. As for the results plotted in FIG. 5, parasitic losses are not taken into account in developing the graph of FIG. 6.

### Advanced Hi-Z Thermoelectric Module

Hi-Z has fabricated an advanced thermopile with large values of L/A. Long polycrystalline elements were fabricated with a proprietary process by essentially ‘stacking’ relatively short polycrystalline elements to achieve a relatively large value of ‘L’ and then providing support on the side surfaces of each element with insulating material. The characteristics of this module are:
Number of n-p couples = N = 162
Module Area = 0.533 cm²
L/A = 1586 cm⁻¹
Module Height = 2.59 cm

FIG. 7 gives a plot of estimated power produced for given input of thermal power Q for the Advanced Hi-Z thermoelectric module. As for the calculations represented by the graphs of FIGS. 5 and 6, parasitic losses were neglected in FIG. 7. FIG. 8 is a plot of estimated power for a given temperature on the hot side (in degrees C) of the thermopile and the cold side of thermopile set to 27° C.

The characteristic that distinguishes the advanced Hi-Z module from the currently available thermopiles is that tens of milliwatts can be obtained from an input of a few tenths of a watt of thermal power due to unique fabrication methods.

In one embodiment of the invention, insulation present inside the housing of the device concentrates heat produced by the tritium-based heating source. This insulation may comprise one or more of several different material types known in the industry, such as aerogels, polyamide, reflective foils, vacuums, or an insulating gas at a low pressure (e.g. Xenon).

In another embodiment, the housing of the system is designed with passive and active components for removing heat from the cold-side (Tc) of the thermoelectric device. Passive heat removal strategies may include radiators, heat pipes, heat sinks, polishing or lapping of surfaces, or contact with other devices that are at a desired temperature. Active heat removal sources may include any devices that can cool the Tc surface, such as Peltier devices, forced convection, phase-change cooling, heat pipes, exposure to the ambient environment, convective cooling, liquid or gas cooling, or electrically cooled surfaces.

The half-life of tritium is sufficiently long that it is reasonable to assume that tritium powered thermoelectric system can have an operational life greater than 20 years.

In one embodiment metal tritide, to serve as a heat source, is deposited as a thin film (nanometers to a few microns, e.g., 4 to 20 microns) onto a metal foil, several foils are stacked and then encapsulated in an enclosure, creating a tritium-based heat source. The heat source is disposed in contact with or proximate the “hot” side of the thermopile 14 of FIG. 1. In another embodiment, (using a titanium film, for example) the metal tritide film is a standalone film or foil that can be stacked to form a composited metal tritide stacked unit. The layered embodiment has a higher tolerance to hydride expansion caused by uptake of the tritium and also provides a volumetrically dense heat source.

Another approach consists of tritiating a layer of metal to form a metal tritide slab (e.g., 100 microns thick) followed by encapsulation within a thermally conductive material that is thermally coupled to the “hot” side of the thermoelectric module. It is also advantageous to direct the heat toward the “hot” side of the thermopile by insulating surfaces of the encapsulating container that are not in contact with nor proximate the “hot” side.

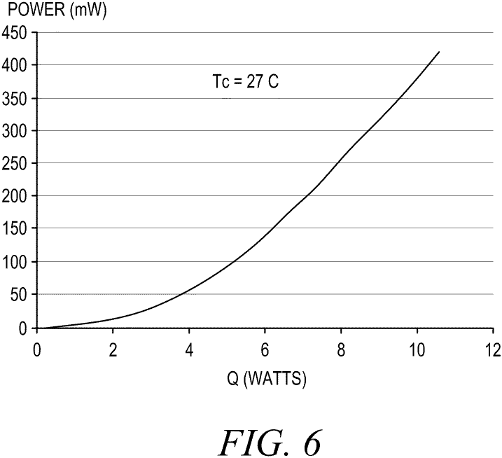

One design approach for a tritium-based heat source 60 is depicted in FIG. 9. A tritiated metal 62 is surrounded on three sides by an insulator 64 and on the fourth side by a material 65 with a high thermal conductivity (greater than about 1 W/m-K) to transfer the heat from the tritiated metal through a thermally conductive paste or film 76 to a hot surface of the thermopile (not shown). Arrowheads 77 indicate the direction of heat flow. A housing 70 encloses the tritium-based heat source 60 and a heat reflector 72 surrounds the housing on three sides for reflecting heat back toward the tritiated metal 62. The heat source 60 is disposed on an insulating material 78.

A metal tritide layer may in certain embodiments be deposited on a thin foil-like substrate (i.e., ~ 25 microns to ~ 500 microns thick) that is then mechanically stacked to form a composite tritium heat source. In another embodiment the metal tritide layer is a standalone thin foil-like substrate (i.e. ~ 4 microns to ~100 microns thick). The metal tritide is formed by exposure to tritium gas at pressures ranging from less than 0.25 Bar to 20 Bar or greater and temperatures ranging less than 100° C. to 600° C. or greater for durations ranging from minutes to days.

In a preferred embodiment, a cap layer of palladium, ranging from approximately 1 nanometer to 500 nanometers thick, is deposited over a substrate prior to loading the substrate with tritium. The substrate may comprise scandium, titanium, magnesium, lithium, or other suitable metals, composites, or alloys. The palladium can be deposited directly on un-passivated surfaces (surfaces containing no oxide barriers to tritiation) of the substrate material. The substrate is also referred to herein as a metal hydride storage material, since the tritium is “stored” within the substrate.

The palladium layer is typically laid down in a vacuum or an inert gas atmosphere, to eliminate oxygen contamination. The palladium is deposited using any of the metal deposition techniques known in the art or described herein.

The palladium is beneficial in that it reduces the tritium loading temperature and stabilizes after formation of the tritide metal matrix. The palladium cap layer functions primarily as a catalyst and serves to provide for an expedited rate of reaction for inducing the tritiation process; palladium has an additional benefit in that it facilitates tritium loading of a metal tritide at significantly lower temperatures compared to processing efforts conducted in the absence of palladium. The subsequent increase in the kinetics of the tritiation process induced by the palladium cap layer does not alter the ultimate functionality of the thermoelectric module,

In other embodiments of the invention, the use of a palladium cap layer may not be necessary or desirable as the tritium loading process can be performed at higher temperatures and/or pressures without risking damage to the system into which the tritide has been incorporated. In such embodiments, the tritium storage can be accomplished with metals such as scandium, titanium, magnesium, lithium, uranium, or other suitable metals, composites, or alloys. The metals may take the form of thin-films, solid bulk quantities of metal, powders, ribbons, sheets, or other form-factors that can be placed in direct contact or contained in a separate enclosure.

Still other embodiments of the invention use platinum (Pt) instead of palladium (Pd). The platinum operates as a catalyst for separating H2 to its constituent H. The platinum will also form a cap layer over titanium, scandium, or magnesium, thereby preventing formation of the oxide barrier. If the platinum is sufficiently thin, it does not prevent easy passage of tritium into the metal, to form the hydride. It should be noted that a metal can be deposited through evaporation or sputtering (or another technique) while preventing the formation of an oxide on the surface. So long as the oxide is not formed, the metal will easily hydride at low temperatures. As with palladium, the objective is to prevent the formation of an oxide barrier on the metal-forming hydride.

In other embodiments of the invention, tritium storage in a matrix material can be accomplished with the use of nonmetals such as carbon, polymers, liquids, composite materials, ceramics, salts, or mixtures thereof.

In other embodiments the metal tritide may be a monolithic component or may be in a powderized form.

The tritium metal tritide may also be encapsulated in aluminum or another highly thermally conductive metal or a container so as to isolate the tritium from the exterior environment and the thermoelectric generator while still providing heat transfer to the generator.

In other embodiments the thermoelectric generator may be replaced by, or combined with, Stirling engines or thermophotovoltaics/thermionics etc., including other thermoelectric generators known in the art.

In one embodiment, the physical form of the tritide material may change from its initial state prior to loading with tritium, e.g., a thin film, slug, slab, ribbon, or another shape of monolithic material prior to introduction of tritium. But after hydride formation, the material may separate into a powder, strips, islands, chunks, or another form. Additionally, after separation of the material into a new form the material volume may increase, a phenomenon that must be considered when designing the material package.

In tritium-based power source, such as those used in a TEG of the present invention, the beta sources are comprised of metal hydride films, holding tritium in a solid form. Each instance of tritium decay forms a helium-3 atom, which is an inert noble gas. As the betavoltaic power source ages over a lifetime exceeding 20 years (the expected power-delivering lifetime of betavoltaic batteries), a buildup of helium-3 will eventually lead to high pressure inside the TEG enclosure. The loss of hermicity of the TEG package and the intrusion of the external atmosphere into the package, can lead to eventual failure of the power source.

The helium can be contained by retaining it interstitially in the metal hydride matrix or it can be contained within the boundaries of the enclosure or containment vessel.

Within the metal hydride matrix, the helium forms local “bubbles” and its eventual release is a function of stress build up, a crack or rupture pathway to the outside of the film, and diffusion forces. The ability of the bubble to move within the material is governed by the bubble pressure and the material lattice strength. The bubble is of course more mobile in a material with a weak lattice strength than in a material with a stronger lattice strength.

Eventually, the bubble will leak “out” of the film and into the area around the film. When this happens, the driving force to leak more helium from the film decreases because now partial pressure of helium in the interstitial space balances the diffusive driving force and the pressure to resist the lattice deformation against interstitial bubbles. On average the helium is retained for an average of 3-4 years in certain tritide films, and then eventually released in a large burst. A slow helium release is preferred, but this phenomenon is a material property that is not well understood.

The helium can be released externally (i.e., from within the TEG enclosure) through various materials and devices including: a vent, a passive or active valve, a diffusion barrier, a permeable membrane, a designed welded leak, vented to a secondary chamber, or other known techniques used for transporting a gas from a high-pressure region to a low-pressure region.

Generally, a permeable membrane is one that allows a much larger item (e.g., solvent molecules, atoms, molecules) to pass through than a diffusion membrane. As applied to the present invention, a permeable membrane allows a higher flux of helium gas to pass through than a diffusion membrane. But properly designed, any membrane will diffuse helium out from the enclosure at a rate that avoids overpressure. Unfortunately, that rate changes over time based on the amount of tritium in the power source, while most membranes have a relatively constant permeability or diffusion rate. If the betavoltaic power source (here serving as a heat source) is loaded with a significant amount of tritium, a more permeable membrane must be used to allow the helium to escape from the enclosure. Conversely, if the helium generation rate is low, a membrane with lower permeability can be used, perhaps even transitioning to a diffusion process to release the helium. Finally, at an extremely low tritium content and therefore extremely low rate of helium generation, a perfect enclosure seal may be sufficient, so long as the slight increase in helium pressure over time can be tolerated.

In one embodiment, the pressure increase due to the helium accumulation is released through a permeable membrane incorporated into the betavoltaic package. The polyimide family of polymers has been identified as a material class with adequate diffusivity and manufacturability to serve as the membrane material. Polyimide shows minimal degradation in response to tritium exposure.

For optimal helium diffusion, the surface area and thickness of the membrane must be carefully chosen. One or more walls of the TEG power source package may incorporate a “window” made of polymer film, with surface area, thickness, and material properties designed to provide adequate diffusion throughout the life of the power source.

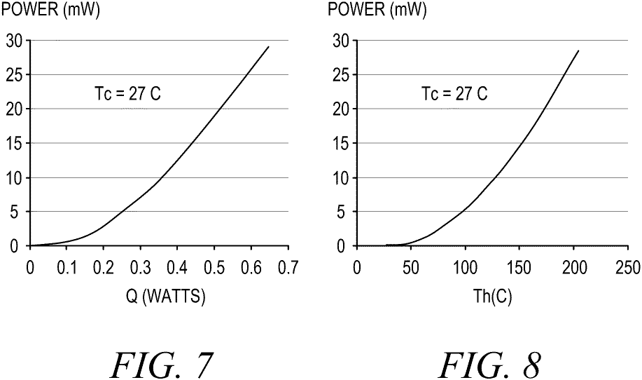

FIG. 10 depicts a polyimide material that can be used for one or more surfaces of the TEG enclosure.

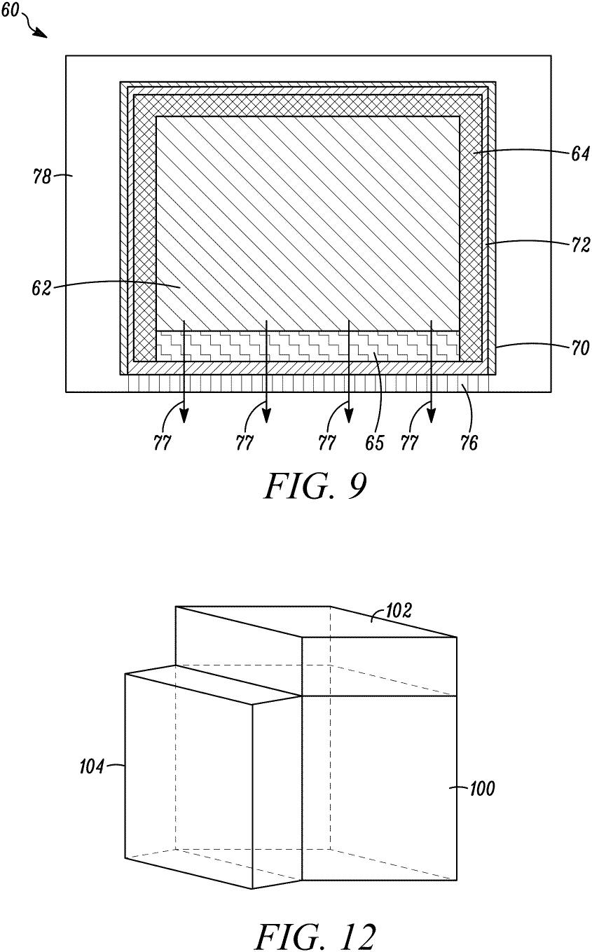

Another embodiment controls the diffusion of helium out of a package through an array of “micro holes” in the package housing (e.g., a metal sheet). Each of these micro holes may be approximately 1-1000 nanometers in diameter, ensuring package water-tightness. This array can be made using various techniques including, but not limited to, ion milling and etching. This approach enables more aggressive outgassing of helium, as the micro holes enable free flow of appropriately sized atoms. FIG. 11 depicts a surface defining a plurality of openings for venting the accumulated He. One or more surfaces of the TEG enclosure can be constructed of this material.

Yet another embodiment controls the diffusion of helium out of a package using an intentionally porous region such as a wall, lid, base, feedthrough, weld, or other feature that may otherwise be normally included in the fabrication of a typical housing for a tritium power source.

An additional feature incorporates a polyimide film over the array of micro holes, thereby creating many microscopic polyimide windows.

In another embodiment, the TEG comprises a first containment polyimide package and an outer-shell second containment comprised of metal, ceramic, or both, and defining micro holes therein through which helium is vented. In this embodiment, micro holes greater than 1,000 nanometers in diameter can be used since the first containment layer provides selective hermeticity to the betavoltaic cells.

One unfortunate consequence of the incorporation of a helium diffusion system in a tritium betavoltaic is the unavoidable release of tritium. In the package’s internal atmosphere, there will inevitably exist some residual tritium from the loading process. It is possible that some amount of tritium may diffuse out with the helium over time, which could result in a measurable dose. This expected dose from this phenomenon is about 5x lower than the average American’s dose from all radiological sources. These sources include background, medical, and occupational sources. The tritium leak rate can be determined by helium leak rate tests and liquid scintillation counting. Despite this low projected dose, it remains prudent to mitigate tritium emission from the package, as humans will be in contact with the TEG of the present invention.

Depleted uranium has been proven as an effective storage medium for tritium because it readily forms UT₃, where the uranium is in the form of a powder, a film, a foil, or a small piece.

One embodiment of a tritium containment feature uses a getter layer. A small amount of depleted uranium may be deposited inside of the enclosure, preferably proximate to any helium diffusion features. As helium diffuses through polyimide membranes and/or micro holes, it will not react with the depleted uranium. Tritium, however, will be gettered by the uranium layer to prevent external tritium contamination. The tritium thereby returns to a solid state inside the betavoltaic battery package. This feature should also reduce the partial pressure of tritium in the package to the microtorr level.

Another embodiment of a tritium containment feature may employ getter materials other than depleted uranium. For example, Zirconium-Cobalt (ZrCo) has been widely studied and used for tritium storage. In this embodiment, a ZrCo getter layer would be deposited adjacent to the helium diffusion system, catching tritium in much the same way as the depleted uranium embodiment.

In another embodiment, the tritium source is contained in a first enclosure that diffuses the He3 gas using methods described herein. A secondary enclosure containing the first enclosure has a getter layer that captures the tritium gas emanating from the first enclosure. The secondary enclosure also diffuses the He3 but getters tritium gas that may have escaped from the first enclosure.

Various TEG embodiments previously described can incorporate a purposeful leak in an electrical feedthrough and/or a joint. Were a feedthrough is designed to leak, it would be enveloped in a polymer or polymer matrix (e.g., polyimide) capable of adequately diffusing helium and capable of electrically isolating it from surrounding metal components. To design a leak in a package joint, one may seal it with a helium-diffusive, electrically isolating polymer or polymer matrix. In the case that these sealing materials are weak to tritium degradation, they may be protected via the incorporation of a tritium containment feature, whether it be a getter material or a diffusion-limiting polyimide film. Polyimide or some other polymer may also be used to isolate conductive package components such as side-walls, lids, and titanium housings, whilst providing helium diffusion rates to sufficiently reduce internal package pressure.

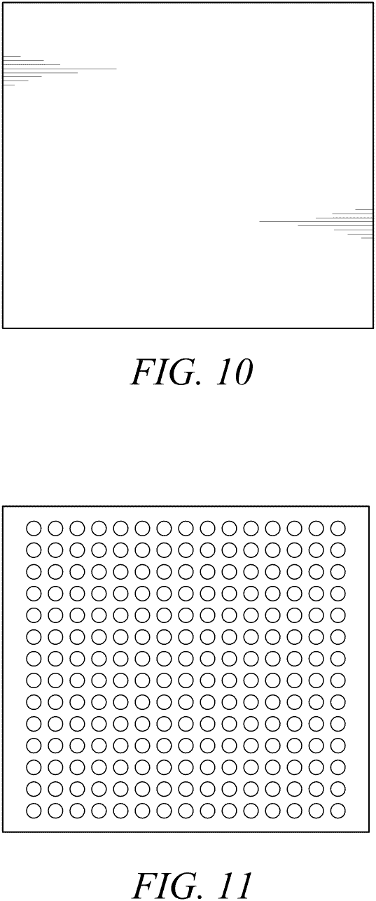

FIG. 12 illustrates an embodiment with a tritium heat source 100 with the hot surfaces of thermopiles 102 and 104 (including the n and p regions and connections therebetween as illustrated in FIGS. 2 and 3) affixed to different faces of the heat source 100. The corresponding cold surface are on an outwardly facing surface of each thermopile 102 and 104.

The heat source can have various form factors, such as a cube, rectangular cube, or another parallelepiped shape. Individual thermoelectric generators (e.g., thermopiles) are disposed on one or more faces of the heat source; two such thermoelectric generators illustrated in FIG. 9. With individual or combined thermoelectric generators on certain surfaces of the heat source, insulators are disposed on the other surfaces to drive the heat into thermoelectric generators. Thermally conductive materials are also employed to drive the heat to the thermoelectric generators.

In one embodiment, with the heat source 100 presenting a cubic form factor, the thermopiles 102 and 104 attached thereto protrude out from the surface of the cube. In one embodiment the thermopiles may protrude a few centimeters, with each surface of the cubic (the heat source) 100 about 4 to 5 cm. in length.

What is claimed is:

1. A device for generating a voltage, comprising:
a source of tritium radioisotopes disposed within an enclosure, the enclosure defined on five sides by an insulator surface and on a sixth side by a thermally conductive surface, a thermal reflective surface disposed spaced-apart from or in contact with an interior-facing surface of each one of the insulator surfaces;
one or more thermally conductive elements Th maintained at a temperature Th;
one or more thermally conductive elements Tc maintained at a temperature Tc, wherein the temperature Tc is lower than the temperature Th;
each one of a plurality of n-doped and p-doped elements having a first surface in thermal communication with one of the one or more thermally conductive elements Th, and a second opposing surface in thermal communication with one of the one or more thermally conductive elements Tc;
elements from among the plurality of n-doped and p-doped elements connected by electrically conductive elements to form a serial electrical string of alternating n-doped elements and p-doped elements, such that current flows through alternating n-doped elements and p-doped elements and through electrically conductive elements connecting n-doped and p-doped elements;
an initial n-doped or p-doped element of the serial string designated a first output terminal and a final n-doped or p-doped element of the serial string designated a second output terminal;
the tritium radioisotopes generating heat within the enclosure, the thermally conductive surface disposed in thermal communication with each one of the one or more elements Th;
a voltage generated between the first and second output terminals due to a temperature differential between the temperatures Tc and Th; and
wherein decay of the tritium radioisotopes generates helium within the enclosure atmosphere, the helium released external to the enclosure through a vent, a passive or active valve, a diffusion membrane, or a permeable membrane.

2. The device of claim 1, wherein the serial string comprises n-doped elements alternating with p-doped elements, wherein a first surface of a first n-doped element and a first surface of a first p-doped element are electrically connected and a second surface of the first p-doped element and a second surface of a second n-doped element are electrically connected.

3. The device of claim 1, wherein the serial string comprises a first surface of a first n-doped element electrically connected to a first surface of a first p-doped element with a first conductive element, and a second surface of the first p-doped element electrically connected to a second surface of a second n-doped element with a second conductive element, the serial string comprising other n-doped and p-doped elements of the plurality of n-doped and p-doped elements similarly connected through first and second surfaces thereof.

4. The device of claim 1, wherein the first surface of each one of a plurality of n-doped and p-doped elements in thermal communication with a thermally conductive element Th, comprises the first surface of each one of the plurality of n-doped elements and p-doped elements in physical contact with the thermally conductive element or a thermally conductive element interposed between the first surface and the thermally conductive element.

5. The device of claim 1, wherein the p-doped and n-doped elements form a serial electrical current flow path such that electrical current flows through the p-doped and n-doped elements and through a load when the load is connected between the first and second output terminals, and wherein the p-doped and n-doped elements are disposed in parallel heat flow paths between the one or more elements Th and the one or more elements Tc.

6. The device of claim 1, wherein a number of n-doped elements equals a number of p-doped elements.

7. The device of claim 1, wherein the source comprises a metal tritium hydride.

8. The device of claim 7, wherein the metal tritium hydride comprises titanium tritide, scandium tritide, magnesium tritide, palladium tritide, lithium tritide, or uranium tritide.

9. The device of claim 7, wherein the metal tritium hydride comprises a layer of palladium.

10. The device of claim 1, wherein the element Tc further comprises a component for removing heat from the element Tc.

11. The device of claim 1, wherein the temperature Tc is between about 300° K to 580° K.

12. The device of claim 1, wherein a semiconductor material of each one of the n-doped and p-doped elements comprises an alloy of SbxTex, BixTex, or BixSex.

13. The device of claim 1, wherein a semiconductor material of each one of the n-doped and p-doped elements comprises a polycrystalline substrate or a single crystalline substrate.

14. The device of claim 1, wherein the device is disposed on a flexible substrate.

15. The device of claim 1, wherein the source of tritium radioisotopes comprises a standalone metal tritide thin film or a standalone metal tritide thin foil.

16. The device of claim 1, wherein the source of tritium radioisotopes comprises a stack of metal tritide thin films encapsulated in an enclosure, or a stack of metal tritide thin foils encapsulated in an enclosure.

17. The device of claim 1, wherein the source of tritium radioisotopes comprises layers of titanium tritide.

18. The device of claim 1, further comprising a uranium getter material within the enclosure to capture residual tritium within the enclosure.

19. A device for generating a voltage, comprising:
a source of tritium radioisotopes disposed within an enclosure;
one or more thermally conductive elements Th maintained at a temperature Th;
one or more thermally conductive elements Tc maintained at a temperature Tc, wherein the temperature Tc is lower than the temperature Th;
each one of a plurality of n-doped and p-doped elements having a first surface in thermal communication with one of the one or more thermally conductive elements Th, and a second opposing surface in thermal communication with one of the one or more thermally conductive elements Tc;
elements from among the plurality of n-doped and p-doped elements connected by electrically conductive elements to form a serial electrical string of alternating n-doped elements and p-doped elements, such that current flows through the alternating n-doped elements and p-doped elements and through electrically conductive elements connecting an n-doped and a p-doped element;
an initial n-doped or p-doped element of the serial string designated a first output terminal and a final n-doped or p-doped element of the serial string designated a second output terminal;
the tritium radioisotopes generating heat within the enclosure for maintaining a temperature of the one or more thermally conductive elements Th;
a voltage generated between the first and second output terminals due to a temperature differential between the temperatures Tc and Th; and
wherein decay of the tritium radioisotopes generates helium within the enclosure atmosphere, the helium released external to the enclosure through a vent, a passive or active valve, a diffusion membrane, or a permeable membrane.

20. The device for generating a voltage of claim 19, wherein the n-doped and p-doped elements are oriented in parallel heat flow paths relative to the thermally conductive elements Th and Tc, and oriented in series current flow path for supplying current to a load connected between the first and second output terminals.
